(19) United States
(12) Patent Application Publication
(10) Pub. No.: US 2022/0161818 A1
(43) Pub. Date: May 26, 2022

(54) METHOD AND SYSTEM FOR SUPPORTING AUTONOMOUS DRIVING OF AN AUTONOMOUS VEHICLE

(71) Applicant: NEC Laboratories Europe GmbH, Heidelberg (DE)

(72) Inventors: Gürkan SOLMAZ, Heidelberg (DE); Everton Luis BERZ, Heidelberg (DE); Jonathan FUERST, Heidelberg (DE); Bin CHENG, Heidelberg (DE); Mauricio FADEL ARGERICH, Heidelberg (DE)

(21) Appl. No.: 17/599,595

(22) PCT Filed: Dec. 6, 2019
(86) PCT No.: PCT/EP2019/084044

§ 371 Date: Sep. 29, 2021

(30) Foreign Application Priority Data
Apr. 5, 2019 (EP) 19167609.7

(51) Int. Cl. B60W 60/00; B60W 40/04; G16Y 40/50; G08G 1/16; G08G 1/0967; G06N 3/02; G06V 20/58; H04W 4/40

(52) U.S. Cl. CPC B60W 60/0011; B60W 2556/50; B60W 60/00274; B60W 40/04; G16Y 40/50; G08G 1/161; G08G 1/166; G08G 1/096725; G06N 3/02; G06V 20/58; H04W 4/40; B60W 2420/42; B60W 2554/4026; B60W 2554/4029; B60W 2554/4041; B60W 2554/4044; B60W 2554/4045; B60W 2556/40; B60W 60/0017

(57) ABSTRACT

A method for supporting autonomous driving of an autonomous vehicle includes detecting, by an in-vehicle internet-of-things (IoT) platform of the autonomous vehicle, a vulnerable road user (VRU) having a mobile device in a vicinity of the autonomous vehicle. A mobility application runs on the mobile device of the VRU and sends VRU-specific data to the in-vehicle IoT platform of the autonomous vehicle. The VRU is detected based on the VRU-specific data and/or in-vehicle sensor data of the autonomous vehicle. The method further includes determining, by the in-vehicle IoT platform, a movement intention prediction based on the VRU-specific data. The movement intention prediction is computed by use of a machine learning model. The VRU-specific data of the mobile device are provided as input data for the machine learning model. In addition, the method includes performing an autonomous driving decision for the autonomous vehicle based on the movement intention prediction.

### CROSS REFERENCE TO RELATED APPLICATIONS

This application is a U.S. National Phase application under 35 U.S.C. § 371 of International Application No. PCT/EP2019/084044, filed on Dec. 6, 2019, and claims benefit to European Patent Application No. EP 19167609.7, filed on Apr. 5, 2019. The International Application was published in English on Oct. 8, 2020, as WO 2020/200502 A1 under PCT Article 21(2).

### STATEMENT REGARDING SPONSORED RESEARCH AND DEVELOPMENT

The project leading to this application has received funding from the European Union's Horizon 2020 research and innovation programme under grant agreement No 731993.

### FIELD

The present disclosure relates to a method and a system for supporting autonomous driving of an autonomous vehicle, in particular in terms of an interaction with a vulnerable road user that is in the vicinity of the autonomous vehicle.

### BACKGROUND

In recent years, there have been major advancements in machine learning research due to increased availability of computation capabilities as well as open datasets (e.g., popularly used labelled image datasets) which allow researchers to easily benchmark their approaches against the state of the art. For example, it is referred to the non-patent literature of A. Geiger, P. Lenz, and R. Urtasun, “Are we ready for Autonomous Driving? The KITTI Vision Benchmark Suite” in Conference on Computer Vision and Pattern Recognition (CVPR), 2012. The KITTI Vision Benchmark Suite is an example of those, specifically used in autonomous driving. Furthermore, the development of machine learning frameworks such as TensorFlow (retrievable at https://www.tensorflow.org/) enables easy prototyping and experimenting with new machine learning systems.

Simultaneously, the concept of Internet of Things (IoT) has been expanding to many domains such as smart cities and smart industries, and it has appealed to more and more researchers in recent years. While various IoT platforms are provided by various major vendors such as Microsoft Azure, AWS IoT, and IBM Watson IoT platform, new large-scale deployments (e.g., city-scale) and experimental testbeds leveraging IoT technologies have become available.

The non-patent literature of R. Bastani Zadeh, M Ghatee, and H. R. Eftekhari, “Three-Phases Smartphone-Based Warning System to Protect Vulnerable Road Users Under Fuzzy Conditions”, IEEE Transactions on Intelligent Transportation Systems, vol. 19, no. 7, pp. 2086-2098, jul 2018 [Online] retrievable at https://ieeexplore.ieee.org/document/8054717/describes a warning system based on smartphones to protect vulnerable road users. The system is activated by a geometric model and a fuzzy inference engine estimates the collision risk. In real-world evaluation samples, results show a 96% accuracy in six types of accident scenarios.

The non-patent literature of M Goldhammer, S. Kauhler, S. Zernetsch, K Doll, B. Sick, and K Dietmayer, “Intentions of Vulnerable Road Users—Detection and Forecasting by Means of Machine Learning,” pp. 1-10, mar 2018 [Online] retrievable at http://arxiv.org/abs/1803.03577 describes movement models based on machine learning methods in order to classify motion state (waiting, starting, moving, stopping) and to predict the future trajectory of vulnerable road users. Results show an accuracy of 88.6% for the motion state classification and a reduction of the trajectory prediction error by 41% on stopping motion scenarios.

### SUMMARY

In an embodiment, the present disclosure provides a method for supporting autonomous driving of an autonomous vehicle. The method includes detecting, by an in-vehicle internet-of-things (IoT) platform of the autonomous vehicle, a vulnerable road user (VRU) having a mobile device in a vicinity of the autonomous vehicle. A mobility application runs on the mobile device of the VRU and sends VRU-specific data to the in-vehicle IoT platform of the autonomous vehicle. The VRU is detected based on the VRU-specific data and/or in-vehicle sensor data of the autonomous vehicle. The method further includes determining, by the in-vehicle IoT platform, a movement intention prediction for the VRU based on the VRU-specific data provided by the mobile device. The movement intention prediction is computed by use of a machine learning model. The VRU-specific data of the mobile device are provided as input data for the machine learning model. In addition, the method includes performing, by the in-vehicle IoT platform, an autonomous driving decision for the autonomous vehicle based on the movement intention prediction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a method or a system according to an embodiment,

FIG. 2 is a schematic view illustrating an overview of an architecture of a system in accordance with an embodiment,

FIG. 3 is a schematic view illustrating a pedestrian movement intention prediction model according to an embodiment,

FIG. 4 is a schematic view illustrating a pedestrian movement intention prediction model according to a further embodiment,

FIG. 5 is a schematic view illustrating a pedestrian movement intention prediction model according to a further embodiment,

FIG. 6 is a schematic view illustrating a petri net model for supporting autonomous driving decision making according to an embodiment, and

FIG. 7 is a schematic view illustrating an interface where pedestrian and vehicle trajectories are visualized for a particular run by animation of real data in discrete time intervals.

### DETAILED DESCRIPTION

The present disclosure provides a method and a system for supporting autonomous driving of an autonomous vehicle in such a way that road safety is improved, in particular in terms of preventing possible accidents between the autonomous vehicle and a vulnerable road user that is in the vicinity of the approaching vehicle.

In accordance with the present disclosure, a method is provided for supporting autonomous driving of an autonomous vehicle, in particular in terms of an interaction with a vulnerable road user that is in the vicinity of the autonomous vehicle. The method includes detecting, by an in-vehicle IoT platform of the autonomous vehicle, a vulnerable road user, ‘VRU’, having a mobile device in the vicinity of the autonomous vehicle, wherein a mobility application runs on the mobile device of the VRU and sends VRU-specific data to the in-vehicle IoT platform of the autonomous vehicle, wherein the VRU is detected based on the VRU-specific data and/or in-vehicle sensor data of the autonomous vehicle; determining, by the in-vehicle IoT platform, a movement intention prediction for the VRU based on the VRU-specific data provided by the mobile device, wherein the movement intention prediction is computed by the use of a machine learning model, wherein the VRU-specific data of the mobile device are employed as input data for said machine learning model; and performing, by the in-vehicle IoT platform, an autonomous driving decision for the autonomous vehicle based on said movement intention prediction.

Furthermore, a system is provided for supporting autonomous driving of an autonomous vehicle, the system comprising an in-vehicle IoT platform that is implemented in the autonomous vehicle and a mobility application running on a mobile device of a vulnerable road user, ‘VRU’, wherein the mobility application running on the mobile device of the VRU is configured to send VRU-specific data to the in-vehicle IoT platform of the autonomous vehicle, wherein the in-vehicle IoT platform of the autonomous vehicle is configured to detect the VRU having the mobile device in the vicinity of the autonomous vehicle, wherein the VRU is detected based on the VRU-specific data and/or in-vehicle sensor data of the autonomous vehicle, wherein the in-vehicle IoT platform is further configured to determine a movement intention prediction for the VRU based on the VRU-specific data provided by the mobile device, wherein the movement intention prediction is computed by the use of a machine learning model, wherein the VRU-specific data of the mobile device are employed as input data for said machine learning model, and wherein the in-vehicle IoT platform is configured to perform an autonomous driving decision for the autonomous vehicle based on said movement intention prediction.

According to the present disclosure, it has first been recognized that an enormous improvement with regard to preventing potential accidents and collisions between the vulnerable road user and the approaching autonomous vehicle can be achieved by leveraging useful information coming directly and voluntarily from the vulnerable road user's mobile device. This in contrast to most of the current autonomous driving systems, which focus only on in-built or attached car sensors and road-side units for taking autonomous driving decisions. Thus, according to the present disclosure, an in-vehicle IoT (Internet of Things) platform of the autonomous vehicle is configured to detect a vulnerable road user (VRU) having a mobile device in the vicinity of the autonomous vehicle. A mobility application runs on the mobile device of the VRU and sends VRU-specific data to the in-vehicle IoT platform of the autonomous vehicle, wherein the VRU is detected based on the VRU-specific data provided by the mobile device and/or based on in-vehicle sensor data of the autonomous vehicle. Thus, the VRU may be detected based on a combination of VRU-specific data from the mobile device and in-vehicle sensor data that is acquired/measured by the autonomous vehicle. The in-vehicle IoT platform is further configured to determine a movement intention prediction for the VRU, based on the VRU-specific data provided by the mobile device, wherein the movement intention prediction is computed by the use of a machine learning model. The VRU-specific data of the mobile device are employed as input data for the machine learning model. Then, the in-vehicle IoT platform can perform an autonomous driving decision for the autonomous vehicle based on the previously determined movement intention prediction.

Thus, the present disclosure provides a method and a system for supporting autonomous driving of an autonomous vehicle, wherein road safety is improved, in particular in terms of preventing possible accidents between the autonomous vehicle and a vulnerable road user that is in the vicinity of the approaching vehicle.

With the advancements in the vehicle to vehicle (V2V) or vehicle to road side as well as vehicle to everything (V2X) communications in the 5G era, the communications from the sensors in the road infrastructure or road side units (RSUs) as well as any mobile device (e.g., smartphone or wearable) close to road side and the car communication can be handled in very short time. Therefore, embodiments of the present disclosure become more feasible in terms of real-time applicability and usage for improving traffic safety.

The term “machine learning model” may refer to a mathematical representation of a process which can be generated with an algorithm using training data. According to embodiments, the machine learning model may be an artificial neural network (ANN).

According to embodiments, an exemplary system may include a mobile device, autonomous car(s), an in-vehicle (edge) IoT platform, and a VRU intention-based decision-making software that runs on top of the platform.

The term “movement intention prediction” may be understood, in particular in the claims, preferably in the description as the possible next movement action of the VRU such as of a pedestrian. Thus, the mobile device user can be considered as the vulnerable road user that may be a pedestrian in the vicinity of an approaching autonomous vehicle/car. The decision-making of autonomous driving may be supplemented with the outcome of a method or system according to an embodiment as a complementary input in order to protect the vulnerable pedestrian.

According to embodiments, it may be provided that, in particular upon detecting of the VRU and prior to determining of the movement intention prediction, a transportation mode of the VRU is determined using a machine learning process. Thus, for example, the machine learning process can determine whether the VRU is a pedestrian or a cyclist. Then, the input data can be fed into a movement intention classifier that computes a movement intention prediction for a VRU using a machine learning model. The machine learning process may include computing the transportation mode of the VRU by the use of a weak supervision-based machine learning model. Weak supervision may be understood as a branch of machine learning for labelling data through noisy or remote labelling sources which are called weak supervisors. Weak supervision enables labelling data through the weak supervisors and therefore avoiding the need for ground-truth collection (labels for peoples' transportation modes). Weak supervised systems such as Snorkel (retrievable at http://snorkel.org) can be used for classifying transport modes through weak supervision.

According to embodiments, it may be provided that video processing is performed based on image data (footage) that is gathered by a sensor device such as a camera of the autonomous vehicle in order to detect the VRU and/or to determine the transportation mode of the VRU. Thus, high-accuracy detection of the VRU and its classification (i.e., pedestrian or cyclist) can be provided.

According to embodiments, the VRU-specific data may include sensor data that are collected by one or more sensors of the mobile device of the VRU. For example, the sensor data may comprise location/position data—in particular GNSS data such as GPS data—, accelerometer data and/or gyroscope data. Thus, the outcome of computations with regard to VRU detection and determination of movement intention prediction is improved.

According to embodiments, the VRU-specific data may include position data, heading angle information and/or (average) speed information of the VRU. Thus, the outcome and accuracy of computations with regard to VRU detection and determination of movement intention prediction is improved.

According to embodiments, the VRU-specific data may include a trajectory of the VRU. Thus, the outcome and accuracy of computations with regard to VRU detection and determination of movement intention prediction can be improved.

According to embodiments, the in-vehicle sensor data may include sensor data that are gathered by one or more sensors of the autonomous vehicle. Thus, the outcome and accuracy of computations with regard to VRU detection and determination of movement intention prediction can be improved.

According to embodiments, the input data for the machine learning model may further include in-vehicle sensor data of the autonomous vehicle for the VRU. Thus, the outcome and accuracy of computations with regard to VRU detection and determination of movement intention prediction can be improved.

According to embodiments, the input data for the machine learning model may further include additional data from one or more IoT data sources. This additional information may provide further information relating to an environment in the vicinity of the autonomous vehicle.

According to embodiments, the additional data may include (online) map data, in particular 3D model data, in order to learn from map features. For example, the map features may include angle to road, distance to road, map landmarks, etc. Thus, the machine learning model (i.e., for instance, the artificial neural network) may learn from the map features and the prediction of the VRU's next movement intention can be determined/computed with higher accuracy.

According to embodiments, the additional data may include internet service data from one or more internet services, wherein the internet service data include information on weather conditions, traffic lights, live events, and/or traffic situations, in an environment of the vicinity of the autonomous vehicle. Thus, the machine learning model (i.e., for instance, the artificial neural network) may learn from these additional information in order to predict the VRU's next movement intention with higher accuracy.

According to embodiments, the additional data may include information on event schedules of the VRU. Thus, the outcome and accuracy of computations with regard to the determination of movement intention prediction for the VRU can be improved.

According to embodiments, the input data for the machine learning model may further include information on the movement history of the VRU. The historical user data may include the VRU's previous traffic-related history of any violation such as jaywalking. These data can be considered for probabilistic prediction of the movement intention for the VRU's next walking movement decision.

According to embodiments, the movement intention prediction that is determined by the machine learning model may represent a user action that is expected to be performed next by the VRU.

According to embodiments, a set of user actions may be defined for the movement intention prediction that is determinable by the machine learning model, wherein the set of actions comprises waiting, walking straight, turning left, turning right and/or turning back (i.e. U-turn).

Embodiments may relate to a method or a system which combines IoT data sources such as measurements of autonomous vehicles' sensors, mobile device users' data and other IoT data sources from internet sources such as online map data and event schedules of mobile device users, to improve autonomous driving decisions taken by autonomous vehicles to improve road safety of pedestrians.

Thus, embodiments may relate to a real-time IoT system for the smart mobility domain. An application scenario for a method or system according to an embodiment may include the following:
1) an autonomous vehicle/car,
2) a mobile device user (i.e. the VRU) with a mobility application running on the mobile device,
3) an in-vehicle IoT platform of the autonomous car,
4) machine learning software engine implemented on the in-vehicle IoT platform, and
5) (optional) other vehicles or IoT data sources.

The machine learning software leverages data sources for training such as GPS data from the mobility application and other open datasets as well as online maps to learn from map features.

According to embodiments, the system first detects existence of a vulnerable road user (VRU) that is a pedestrian in the vicinity of an approaching autonomous vehicle/car. If the VRU is using the mobility application, the mobile device of the VRU directly (through V2V) or indirectly (through 4G/5G) transmits VRU-specific data to the in-vehicle IoT platform of the autonomous vehicle. Then, the machine learning software implemented on the in-vehicle IoT platform of the autonomous vehicle predicts the movement intention of the pedestrian, wherein the movement intention can be defined as the next movement choice with a simple set of actions: for instance, waiting, walking straight, turning left, turning right, and/or turning back.

For determining the movement intention prediction, the machine learning software engine is trained with datasets including location/position data (such as GPS data), heading information, and speed information as well as map features. Furthermore, the machine learning software engine may incorporate data sources such as event schedule (e.g., lecture schedule in a university campus) of the mobile device user, if the data is available in a timely manner. Lastly, the system components on the in-vehicle IoT platform of the autonomous car may decide on the autonomous driving action such as slowing down the car, keeping the same speed, or breaking the car in unsafe situations. This decision is based on VRU detection and pedestrian intention prediction models to assess safety based on information from in-vehicle sensors and mobile device data (i.e. VRU-specific data).

According to embodiments, the data may be collected in the in-vehicle IoT platform. The software engine for VRU detection, the VRU movement intention prediction, and autonomous driving decision may be part of (or may run on top of) the in-vehicle IoT platform. The in-vehicle IoT platform can be considered as an edge component. The communication can be done directly in between the mobile device, autonomous car, or RSU. In the case of internet sources, they can be reached using 4G/5G communications. Some of the internet sources such as lecture schedule in a campus or weather information can be gathered before the pedestrian comes to the road side.

At least one embodiment may have at least one of the following advantages and characteristics:
A system and a method according to an embodiment improve autonomous driving safety by leveraging IoT data sources and mobile device data of pedestrian, whereas most of the current systems rely on car or road-side sensors.
A system and a method according to an embodiment may complement the current state of the art with additional input to consider before making autonomous decisions. It may be particularly useful in the case of absence of cameras or obstacle presence.
Embodiments aim at providing an extra-layer of security for pedestrians by combining different sources of data. In specific places such as smart cities or smart campuses, it may be useful as the people may use the mobility application given by the organization.
Embodiments leverage useful information coming directly and voluntarily from pedestrians' mobile devices as well as their IoT information such as their event schedules or internet-based services for scheduled events in urban areas. Embodiments can be considered complementary to existing autonomous driving decision systems and can be used as an additional input for decision-making.

There are several ways how to design and further develop the teaching of the present disclosure in an advantageous way. To this end, it is to be referred to the following explanation of further embodiments illustrated by the figures on the other hand.

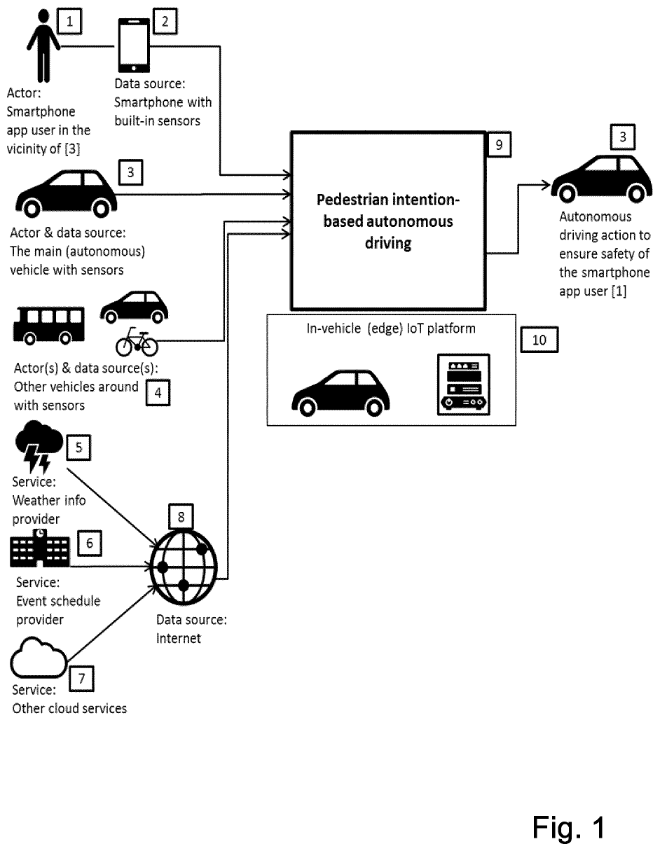

FIG. 1 shows a schematic view illustrating a method or a system according to an embodiment. FIG. 1 gives a simplistic overview of an idea of pedestrian intention-based autonomous driving in accordance with an embodiment. A main target of the embodiment is an understanding of pedestrian movement intentions using and combining available IoT (Internet of Things) data sources as well as pre-trained prediction components in-vehicle. Possible data sources and actors are listed on the left side of FIG. 1, given as inputs to the autonomous driving, while the outputs are the autonomous driving decisions that are applied to the vehicle/car on the right side of FIG. 1.

The approach according to the embodiment may comprise the following steps: (1) vulnerable road user (VRU) detection, (2) pedestrian intention prediction, and (3) autonomous decision making.

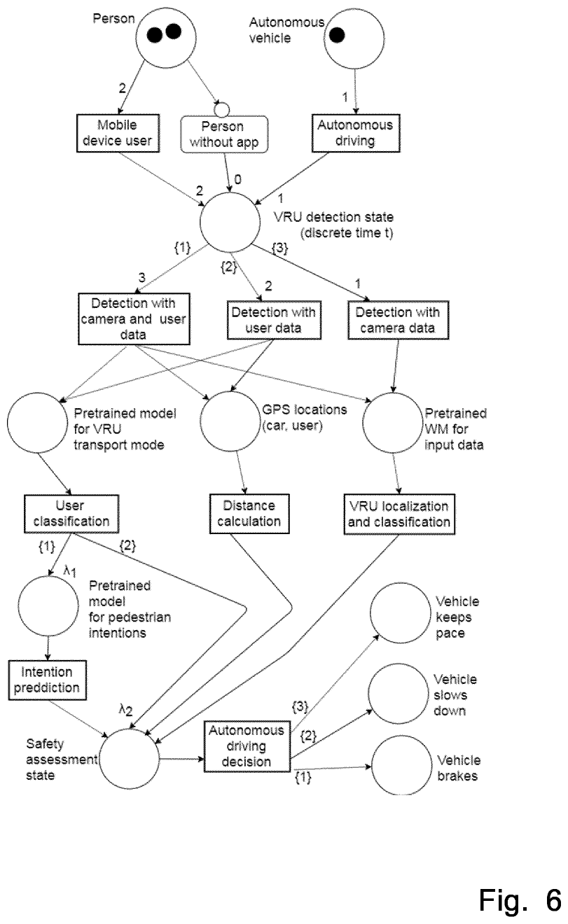

The first step leverages video processing based on footage received from a camera deployed in the vehicle/car for high-accuracy detection of vulnerable road users (VRUs) and their classification (i.e., pedestrian and cyclist). The second step leverages smartphone data (e.g., GPS, gyroscope) and internet sources (e.g., map data) to predict the pedestrian's movement intentions. In the second step, long-term historical data from pedestrians for pre-training may also be used. The third step combines the outcome/output from the first two steps and makes an autonomous driving decision. In this regard, a petri net model for classifying behaviors such as slowing down may be considered, for example as illustrated by FIG. 6.

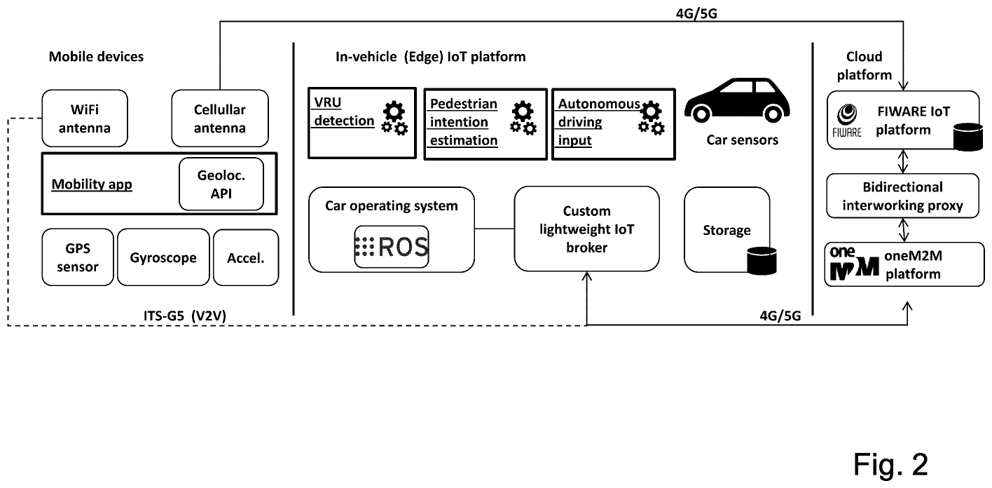

FIG. 2 shows a schematic view illustrating an overview of a system architecture for a method or a system in accordance with an embodiment. The embodiment illustrated by FIG. 2 comprise three main participants as follows: in-vehicle IoT platform, mobile device, and cloud IoT platform.

The key components relevant to implementing the embodiment for VRU and/or pedestrian intention-based autonomous driving are marked as squared boxes with underlined text in FIG. 2, whereas all other components that may be required are presented in rounded boxes.

The key components of FIG. 2 comprise a mobility application implemented on the mobile device. Further, the key components comprise a VRU detection entity, a pedestrian intention estimation entity and an autonomous driving input entity, which are all implemented on the in-vehicle IoT platform of the car.

In-vehicle IoT platform: The custom-built autonomous car/vehicle of the described embodiment includes various sensors such as cameras, Mobileye, Lidar, and so on. The in-vehicle IoT platform contains a Robot Operating System (ROS), which can be considered as the operating system of the car. ROS receives/collects the data published from various sensors, in-vehicle software components (e.g., analytics, image/video processing components), mobile devices (e.g., the mobility app for smartphones), as well as the cloud platform. The collection from the cloud platform and the mobile devices is supported by a custom-developed lightweight IoT broker component. This component queries/subscribes to these other sources and deliver the data to the ROS. The ROS files are stored in the storage. There are three components, which can also be seen as standalone applications running on the in-vehicle IoT platform. For testing or simulation purposes using collected offline data, VRU detection and pedestrian intention estimation components can be run offline using rosbag files (i.e., simulation using real data). As these components run on ROS environment using the same ROS data, with the same setup they can be transferred to a real setup in the in-vehicle IoT platform. The autonomous driving input component is considered for providing valuable input to autonomous driving by leveraging and combining the outputs of the VRU detection and pedestrian intention estimation.

Mobile device: Any mobile device such as smartphones and wearables with sensors and communication capabilities may be considered as possible components of the system from the VRU side. The system involves the usage of mobile devices by the VRUs. The mobile devices include a set of sensors, antennas for communication, as well as the mobility app, i.e. the mobility application. The sensors of the mobile device include, e.g., GPS, gyroscope and accelerometer. The mobile device push data through 4G communication (or 5G in the near future). The communication capabilities may include vehicle to vehicle (V2V) protocols such as ITS-G5 for direct communication to the vehicle. This communication can be satisfied only in the case that the VRU and the autonomous vehicle are in the wireless range of each other (i.e., less than 100 m). The mobility application collects the sensory data and pushes it to the cloud (or optionally to in-vehicle platform). The mobility application uses a geo-location API (Application Programming Interface).

Cloud IoT platform: Although the cloud platform includes various components and different aspects, in this embodiment it is focused on the two standard-based IoT platforms that are mainly used for collecting and providing the VRU mobility-related data: FIWARE (retrievable at https://www.fiware.org/) and oneM2M (retrievable at http://www.onem2 m.org/). The data from the mobility application can be pushed to FIWARE IoT platform which is bidirectionally connected to the oneM2M platform through a custom-developed interworking proxy component, which handles the data exchanges and format convergence in between these two standard-based platform.

A system according to an embodiment such as illustrated by FIG. 2 may perform steps as follows:

### Step 1: VRU Detection

Considering a single person as vulnerable road user (VRU), the method may have three cases of VRU detection: Case 1: existence of only mobile device data, i.e. the VRU-specific data; Case 2: existence of only camera data, i.e. in-vehicle sensor data; and Case 3: existence of both camera data and mobile device data for the VRU

In case 1, the location/position data is received from the mobile device into the in-vehicle IoT platform. The location/position data is leveraged for later safety assessment and autonomous driving decision based on that.

In the case 2, the image processing is used. This model extracts all obstacles from image processing and if it is a person, classifies the type of the person (i.e., pedestrian or cyclist) using the images. Moreover, the image processing can compute the relative position of the person to the vehicle.

In the case 3, both camera data and mobile device data are collected in the in-vehicle platform. In this case, the image processing finds the relative positions and combines with the vehicle location data (i.e., GPS) to find the coordinates of the obstacles. Then, the VRU detection compares this information about the coordinates from multiple obstacles with the coordinates available from the mobile device(s). This comparison is performed over multiple image frames for a predetermined period of time (e.g., 8 frames/second) and the best match obstacle is marked as the mobile device user. In this case, the VRU detection is performed using camera data measured by the autonomous vehicle.

### Step 2: Transportation Mode Detection

A machine learning model is trained to classify the transportation mode of vulnerable road users. This classification, performed by a machine learning process, is required to identify VRUs such as pedestrians and bicyclists before their data is fed into the movement intention classifier that computes a movement intention prediction for a VRU using a machine learning model (such as an artificial neural network). For not relying on extensive labeling of ground truth transportation modes via crowdsourcing, a weak supervision can be applied to quickly collect vast amounts of noisy training data. Specifically, a weak supervision-based machine learning model is used, where multiple supervisors are defined based on subject matter expert knowledge (e.g., bicycle, pedestrian, car speed constraints, length of trip, sequence of trip segments), geographical information from existing knowledge bases (e.g., bus and train stops from OpenStreetMap) and other integrated third party data sources (e.g., weather data). These labeling functions are applied on detected trips and trip segments that have been integrated with OpenStreetMap and weather data. Based on the resulting probabilistic labels, the machine learning model can then be trained. The provided model is able to generalize the training data and apply it to mobility data from other deployments and cities without a repeated collection of training data (e.g., through crowd-sourcing or manual labeling).

### Step 3: Vru/Pedestrian Movement Intentions

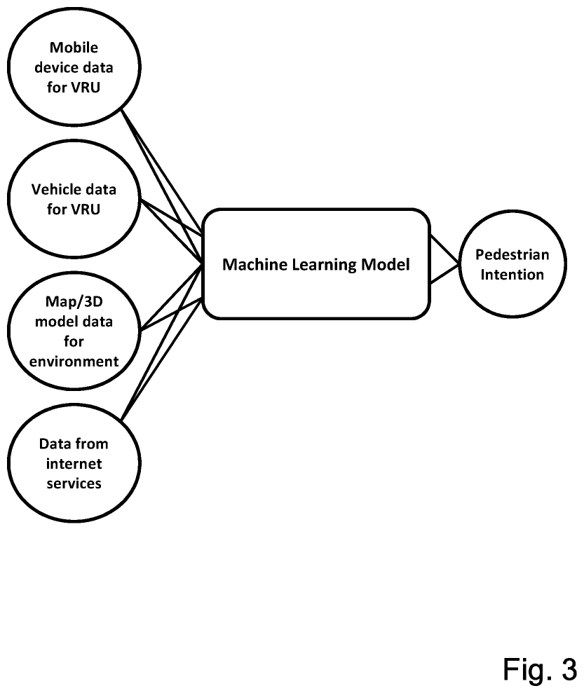

A method in accordance with an embodiment includes a step of estimating/determining the next movement action of the vulnerable road user. In this regard, it is referred to FIG. 3 that shows a schematic view illustrating a pedestrian movement intention prediction model according to an embodiment. Specifically, FIG. 3 shows a method of an embodiment that combines personal information, i.e. VRU-specific data coming from the mobile device of the VRU, and in-vehicle sensor data for VRU as well as information from IoT data sources such as map/3D model environmental data and data from internet services. The described data include the latest movement steps (short trajectory) of the pedestrian and mobile devices sensors (e.g., heading), user data (i.e., event schedule, movement history of the user), position of pedestrian using the previous VRU detection step, map features (e.g., distance to road, angle to road), and data from cloud/edge IoT services (e.g., traffic lights, live events/traffic situation/other information in the environment). The historical user data may include the user's previous traffic-related history of any violation such as jaywalking. These data is considered for probabilistic prediction of the “pedestrian intention” for their next walking movement decisions.

According to embodiments, the proposed machine learning model uses mobile device's sensor data such as the GPS trajectory values of pedestrians in order to predict their next movements. An Artificial Neural Network (ANN) is modelled, consisting of n neurons in the input layer and five neurons as output, where n is the number of steps from the previous pedestrian trajectory from t_1 until t_n, plus the heading angle and average speed information. Each output neuron represents the next movement intention or turn direction of the pedestrian, i.e. waiting, walking straight, turning right, turning left or U-turn (i.e., turning back).

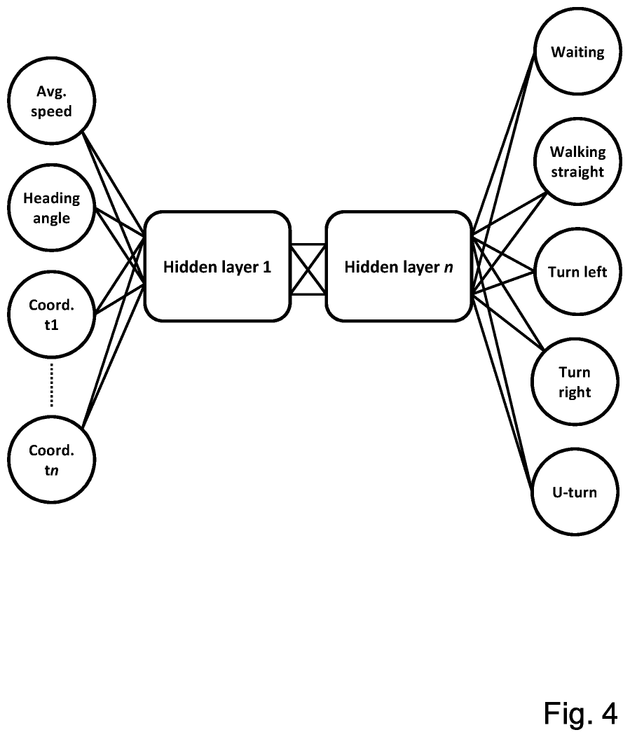

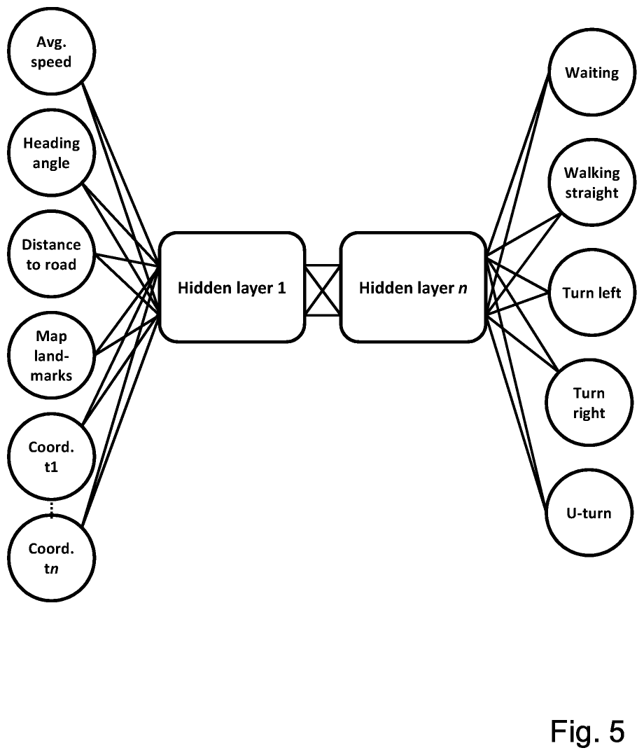

FIG. 4 and FIG. 5 illustrate a neural network model considering a basic ANN (without map features) and an ANN with using map features according to embodiments. Thus, FIG. 4 shows an example of a neural network model for movement intention prediction of a pedestrian, using only features of the mobile device (not using other IoT sources). FIG. 5 shows a further example of a neural network model for movement intention prediction of a pedestrian, using features of the mobile device together with map features and possibly other IoT sources.

The machine learning model training process is fed by the data collected in the offline phase and the mobile device data, i.e. the VRU-specific data, is partitioned into training, validation and testing datasets.

Based on the concept of data programming, a method according to an embodiment provides heuristic rules applied over a geometric model to help in the creation of labeled training sets. Thus, it is not necessary to manually collect labeled intentions from pedestrians, as the training process uses the results from labeling functions. As part of the labeling function, well-known geometric formulas are applied to calculate the bearing (direction or angle between the north-south line of earth or meridian and the line connecting the target and the reference point) of movement in degrees and, based on this angle and the walked distance, a set of rules are applied to give the turning direction, waiting or walking straight status. Except than the map features using services such as OpenStreetMap, the machine learning model can be extended using other data coming from the mobile device user (i.e. the VRU) such as the appointment schedule (e.g., lecture schedule of a student in a university campus) or the next navigation destination as well as events from the online sources such as large-scale events in a city to improve the movement intention prediction accuracy.

The equation below presents a final labeling function with heuristic rules for state and direction definition:

$$f ( a , b , c ) = \{ \begin{matrix}waiting , & if {d}_{ab} + {d}_{bc} < {T}_{d} \\ right , & if ( δ < - 180 - {T}_{a} ) ⩔ \\ & ( δ > {T}_{a} ⩓ δ < 180 - {T}_{a} ) \\ left , & if ( δ > 180 + {T}_{a} ) ⩔ \\ & ( δ < 0 - {T}_{a} ⩓ δ > - 180 + {T}_{a} ) \\ straight , & if δ \geq 0 - {T}_{a} ⩓ δ \leq {T}_{a} \\ uturn , & otherwise ,\end{matrix}$$

where a, b and c are two line segments representing the pedestrian trajectory, δ is the normalized angle of direction from (a,b) to (b,c), dₓᵢ is the Haversine distance between coordinates (x,y), T_{d} and Tₐ are the threshold (tolerance) from the distance and angle of movement, respectively.

Thus, the embodiment combines position information from in-vehicle image processing with the data (i.e. VRU-specific data) from the mobile device for pedestrian movement intention detection. This can be done by finding in the image processing VRU detection results the corresponding mobile device user (i.e., matching image of pedestrian to mobile device data source) for leveraging camera-based positioning when applicable through the aforementioned Step 1 and Step 2 (for only Case 3).

### Step 4: Autonomous Decision-Making

A method in accordance with an embodiment includes a step of performing an autonomous driving decision for the autonomous vehicle/car. How to support autonomous decision-making using the results from the previous steps can be described as follows: Autonomous decision making can be a final step of the proposed procedure. According to embodiments, this step is built on top of the previously described steps. Here, a simple model using stochastic priority petri nets is used in order to illustrate a procedural method. FIG. 6 shows a schematic view illustrating a petri net model for supporting autonomous driving decision making according to an embodiment.

Specifically, FIG. 6 shows the model with places (big circles), transitions (rectangles), and the tokens at the initial stage. In FIG. 6, λ denotes the probabilistic variables based on the transition step, whereas the curly-braced numbers indicate the priority labels and numbers without curly braces denote the number of tokens.

In the embodiment illustrated by FIG. 6, an existence of two types of people (i.e., vulnerable road users) is considered:
1) mobile device users, meaning the users who downloaded the mobility application in their mobile device, and
2) people without mobility application who may or may not have mobile devices.

The initial places on the top (person and autonomous vehicle) are fired in the case of autonomous driving. In this embodiment, three possible cases during driving are considered:
1) when mobile device user and vehicle camera data both available in the in-vehicle IoT platform,
2) only mobile device data is available,
3) only vehicle camera data is available.

For cases 1) and 3), a pre-trained world model is used to create a list of VRUs and classify them (i.e., pedestrian or cyclist). For case 1), the found VRUs are also matched with the mobile device data. The outputs of the pre-trained model are given for assessing the safety (the bottom-left place).

For case 2), the distance is calculated and given to safety assessment using vehicle and person location data. For case 1), the pre-trained model is used to probabilistically predict the transport mode. In the case of pedestrian mode, the pre-trained model for pedestrian movement intentions is used to predict. This input is also given to the safety assessment. Other than the shown inputs, other vehicle- or person-related data can also be used by the autonomous driving decision making to decide based on a set of final actions (illustrated bottom-right of FIG. 6). For simplicity, three probabilistic actions for safety are defined:
1) keeping the same pace,
2) slowing down,
3) breaking.

An extended model might be applied for more complex behaviors.

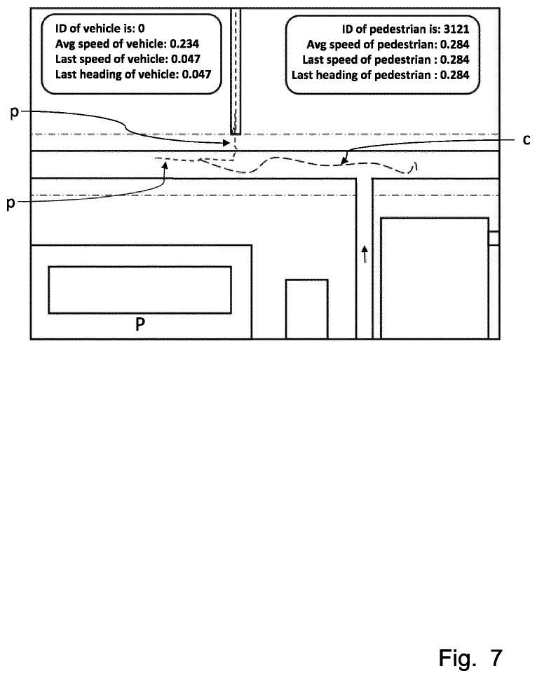

Finally, FIG. 7 shows a schematic view illustrating an interface where pedestrian and vehicle trajectories are visualized for a particular run by animation of real data in discrete time intervals. Thus, FIG. 7 illustrates the map-view interface for controlled experiments. The short trajectory p on the left side represents the pedestrian. The longer trajectory c on the right side represents the car.

With regard to an evaluation of this embodiment, autonomous driving pilot tests have been conducted mainly at a university campus while some tests are conducted at a business campus. The tests are conducted by collaboration of multiple multi-domain research groups. The university campus has a 2-km road network and 30 km/h speed limit for cars. A custom-built autonomous car prototype (Toyota Prius) is used in the tests. The car has a custom mobile ITS-G5 device connected to the in-vehicle IoT platform. Furthermore, two VRUs carry these ITS-G5 devices. The broker in the in-vehicle IoT platform is connected to cloud platforms (oneM2M via MQTT and FIWARE via HTTP) using cellular 4G connection. Integration tests and three pilot tests (each about 1 to 2 weeks-long) are conducted in one-year time period. The data from the pilot tests are collected as rosbag files as well as CSV files. Each software component in the vehicle or the cloud (via the IoT broker) publishes data to ROS in real time. After data collected through controlled experiments, they analyzed to see the performance of the VRU detection as well as the pedestrian intention estimation. As the controlled experiments, 21 experiments (consisting of total 70 70 runs) are conducted where the VRU behavior is predefined, whereas the autonomous driving behaviors are mostly not predefined and the driving is affected by the vehicle sensors or other factors. The controlled experiments includes both autonomous and manual driving modes. Various tools can visualize the experimental data. FIG. 7 shows the interface where the pedestrian and car trajectories for a particular run by animation of the real data in discrete time intervals.

Thus, the embodiment leverages the potential of using IoT technologies (i.e., data sources, platforms) and machine learning for enhancing the autonomous driving in terms of safety and efficiency. It is proposed a method and a system which combines IoT data sources such as measurements of autonomous vehicles' sensors, mobile device users' data and other IoT data sources from Internet such as OpenStreetMap data. The required components of the system includes a mobile device, autonomous car(s), an in-vehicle (edge) IoT platform, and the pedestrian intention-based decision-making software which runs on top of the in-vehicle (edge) IoT platform. Here, the mobile device user is considered as a vulnerable road user who may be a pedestrian in the vicinity of an approaching autonomous car. While the IoT platform receives real-time updates from the IoT data sources, the decision-making is trained via deep neural networks to predict the pedestrians intentions for their next movement decisions using historical data from the custom-developed autonomous car and the data collected from the mobile device mobility application.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for supporting autonomous driving of an autonomous vehicle, the method comprising:
detecting, by an in-vehicle internet-of-things (IoT) platform of the autonomous vehicle, a vulnerable road user (VRU having a mobile device in a vicinity of the autonomous vehicle, wherein a mobility application runs on the mobile device of the VRU and sends VRU-specific data to the in-vehicle IoT platform of the autonomous vehicle, wherein the VRU is detected based on the VRU-specific data and/or in-vehicle sensor data of the autonomous vehicle;
determining, by the in-vehicle IoT platform, a movement intention prediction for the VRU based on the VRU-specific data provided by the mobile device, wherein the movement intention prediction is computed by use of a machine learning model, wherein the VRU-specific data of the mobile device are provided as input data for the machine learning model; and
performing, by the in-vehicle IoT platform, an autonomous driving decision for the autonomous vehicle based on the movement intention prediction.

2: The method according to claim 1, wherein upon the detecting of the VRU and prior to the determining of the movement intention prediction, the method further comprises:
determining a transportation mode of the VRU using a machine learning process, wherein the machine learning process includes computing the transportation mode of the VRU by use of a weak supervision-based machine learning model.

3: The method according to claim 1, wherein video processing is performed based on image data gathered by a sensor device of the autonomous vehicle in order to detect the VRU and/or to determine the transportation mode of the VRU.

4: The method according to claim 1, wherein the VRU-specific data include sensor data that are collected by one or more sensors of the mobile device of the VRU.

5: The method according to claim 1, wherein the VRU-specific data include position data of the VRU, heading angle information of the VRU, and/or speed information of the VRU.

6: The method according to claim 1, wherein the VRU-specific data include a trajectory of the VRU.

7: The method according to claim 1, wherein the in-vehicle sensor data include sensor data that are gathered by one or more sensors of the autonomous vehicle.

8: The method according to claim 1, wherein the input data for the machine learning model further include in-vehicle sensor data of the autonomous vehicle for the VRU.

9: The method according to claim 1, wherein the input data for the machine learning model further include additional data from one or more IoT data sources.

10: The method according to claim 9, wherein the additional data include map data in order to learn from map features.

11: The method according to claim 9, wherein the additional data include internet service data from one or more internet services, wherein the internet service data include information on weather conditions, traffic lights, live events, and/or traffic situations, in an environment of the vicinity of the autonomous vehicle.

12: The method according to claim 9, wherein the additional data include information on event schedules of the VRU.

13: The method according to claim 1, wherein the movement intention prediction represents a user action that is expected to be performed next by the VRU.

14: The method according to claim 1, wherein a set of user actions is defined for the movement intention prediction that is determinable by the machine learning model, wherein the set of actions comprises waiting, walking straight, turning left, turning right and/or turning back.

15: A system for supporting autonomous driving of an autonomous vehicle, the system comprising:
an in-vehicle internet-of-things (IoT) platform implemented in the autonomous vehicle and a mobility application running on a mobile device of a vulnerable road user (VRU),
wherein the mobility application running on the mobile device of the VRU is configured to send VRU-specific data to the in-vehicle IoT platform of the autonomous vehicle,
wherein the in-vehicle IoT platform of the autonomous vehicle is configured to detect the VRU having the mobile device in a vicinity of the autonomous vehicle, wherein the VRU is detected based on the VRU-specific data and/or in-vehicle sensor data of the autonomous vehicle,
wherein the in-vehicle IoT platform is further configured to determine a movement intention prediction for the VRU based on the VRU-specific data provided by the mobile device, wherein the movement intention prediction is computed by use of a machine learning model, wherein the VRU-specific data of the mobile device are provided as input data for the machine learning model, and
wherein the in-vehicle IoT platform is configured to perform an autonomous driving decision for the autonomous vehicle based on the movement intention prediction.
